(19) United States
(12) Patent Application Publication
(10) Pub. No.: US 2015/0026351 A1
(43) Pub. Date: Jan. 22, 2015

(54) ONLINE SESSION TRANSFER

(71) Applicant: Bank of America Corporation, Charlotte, NC (US)

(72) Inventors: Matthew A. Calman, Charlotte, NC (US); Dipika Jain, Charlotte, NC (US); William E. Kelley, Charlotte, NC (US); Michael E. Toth, Charlotte, NC (US); Chris Purvis, Waxhaw, NC (US)

(73) Assignee: Bank of America Corporation, Charlotte, NC (US)

(21) Appl. No.: 13/946,425

(22) Filed: Jul. 19, 2013

(51) Int. Cl. H04L 29/06

(52) U.S. Cl. CPC H04L 65/1066
USPC 709/227

(57) ABSTRACT

Embodiments for transferring online account sessions are included in systems that enable a user to transfer control of an account session from a first mobile device to a second mobile device and determine whether or not the second mobile device has control of the account session based on transmission data received from the first mobile device or second mobile device. The systems receive transaction data, user input, or device tracking data from the first device or second device, and use the data to process online activities.

### BACKGROUND

Users of mobile device applications often access online accounts at home or when traveling. Online account activity can encompass a wide array of activity such as contacting friends, providing feedback, making purchases, retrieving account data, and so forth. However, in some instances, a user may not desire or may not be able to complete an online account activity due to security concerns, spotty network coverage, or current engagements. In such instances, using mobile devices for online account activity can become frustrating to users.

### BRIEF SUMMARY

The embodiments provided herein are directed to systems for transferring online account sessions. In some embodiments, the systems include a computer apparatus including a processor and a memory and a transfer module stored in the memory, comprising executable instructions that when executed by the processor cause the processor to allow a first user to launch an account session on a first mobile device via an application stored on the first mobile device. In some embodiments, the executable instructions further cause the processor to receive first session data from the first mobile device, the first session data comprising at least one of transaction data, user input, and device tracking data. In some embodiments, the executable instructions further cause the processor to allow the first user to transfer control of the account session from the first mobile device to a second mobile device. In some embodiments, the executable instructions further cause the processor to determine whether or not the second mobile device has control of the account session based on transmission data received from the first mobile device or second mobile device.

In other embodiments of the systems, the executable instructions further cause the processor to determine that the second mobile device has control of the account session; receive second session data from the second mobile device; and process an online activity based on the first action session data or the second action session data, where the online activity comprises at least one of inbound transactions, outbound transactions, and account updates. In other embodiments, the executable instructions further cause the processor to allow the first user or a second user to return control of the account session from the second mobile device back to the first mobile device; and determine that the first mobile device is in control of the account session. In further embodiments, the executable instructions further cause the processor to cancel the account session on the first mobile device upon determining that the second mobile device has control of the account session; or set the account session on the first mobile device to an inactive control mode upon determining that the second mobile device has control of the account session.

In additional embodiments, the executable instructions further cause the processor to determine that the second mobile device does not have control of the account session; and prompt a user of the second mobile device to register the second mobile device upon determining that the second mobile device does not have control of the account session, where the user of the second mobile device comprises the first user or a second user. In some embodiments, the executable instructions further cause the processor to restore control of the account session on the first mobile device; and process an online activity based on the first session data. In other embodiments, the executable instructions further cause the processor to cancel the account session on the first mobile device.

In other embodiments, the executable instructions further cause the processor to receive a login request from the first mobile device, the login request comprising device information and user information; compare the login request with device registration records; and confirm that the first mobile device is a registered device. In still other embodiments, the executable instructions further cause the processor to provide an active control indicator or an inactive control indicator on a display of the first mobile device or on a display of the second mobile device. In some embodiments, the executable instructions further cause the processor to provide a split screen on at least one of the first mobile device and the second mobile device, where a first portion of the split screen displays the account session in an inactive control mode and a second portion of the split screen displays the account session in active control mode. In further embodiments, the executable instructions further cause the processor to determine that the active session on the first device is in the inactive control mode and limit the type of actions that the first user can perform in the inactive control mode.

Further provided herein are embodiments directed to a computer program product for transferring online account sessions. In some embodiments, the computer program product comprises a computer readable storage medium having computer readable program code embodied therewith, the computer readable program code comprising computer readable program code configured to allow a first user to launch an account session on a first mobile device via an application stored on the first mobile device. In some embodiments, the computer program product further includes computer readable program code configured to receive first session data from the first mobile device, the first session data comprising at least one of transaction data, user input, and device tracking data. In some embodiments, the computer program product further includes computer readable program code configured to allow the first user to transfer control of the account session from the first mobile device to a second mobile device. In some embodiments, the computer program product further includes computer readable program code configured to determine whether or not the second mobile device has control of the account session based on transmission data received from the first mobile device or second mobile device.

In further embodiments, the computer program product further includes computer readable program code configured to determine that the second mobile device has control of the account session; receive second session data from the second mobile device; and process an online activity based on the first action session data or the second action session data, wherein the online activity comprises at least one of inbound transactions, outbound transactions, and account updates. In other embodiments, the computer program product further includes computer readable program code configured to allow the first user or a second user to return control of the account session from the second mobile device back to the first mobile device; and determine that the first mobile device is in control of the account session. In still other embodiments, the computer program product further includes computer readable program code configured to determine that the second mobile device does not have control of the account session; and prompt a user of the second mobile device to register the second mobile device upon determining that the second mobile device does not have control of the account session, where the user of the second mobile device comprises the first user or a second user. In additional embodiments, the computer program product further includes computer readable program code configured to receive a login request from the first mobile device, the login request comprising device information and user information; compare the login request with device registration records; and confirm that the first mobile device is a registered device.

In additional embodiments, a computer-implemented method for transferring online account sessions is provided. In some embodiments, the method includes allowing a first user to launch an account session on a first mobile device via an application stored on the first mobile device. In some embodiments, the method includes receiving first session data from the first mobile device, the first session data comprising at least one of transaction data, user input, and device tracking data. In some embodiments, the method includes allowing the first user to transfer control of the account session from the first mobile device to a second mobile device. In some embodiments, the method includes determining, by a processor, whether or not the second mobile device has control of the account session based on transmission data received from the first mobile device or second mobile device.

In further embodiments, the method includes determining, by a processor, that the second mobile device has control of the account session; receiving second session data from the second mobile device; and processing, by a processor, an online activity based on the first action session data or the second action session data, where the online activity comprises at least one of inbound transactions, outbound transactions, and account updates. In other embodiments, the method includes allowing the first user or a second user to return control of the account session from the second mobile device back to the first mobile device; and determining, by a processor, that the first mobile device is in control of the account session. In still other embodiments, the method includes determining, by a processor, that the second mobile device does not have control of the account session; and prompting, by a processor, a user of the second mobile device to register the second mobile device upon determining that the second mobile device does not have control of the account session, where the user of the second mobile device comprises the first user or a second user.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1 is a flowchart illustrating a process enrolling a mobile device in accordance with various embodiments;

FIG. 2A is an illustration of a graphical user interface for enrolling a mobile device in accordance with various embodiments;

FIG. 2B is an illustration of a graphical user interface for enrolling a mobile device in accordance with various embodiments;

FIG. 3 is a system and environment for transferring online sessions in accordance with various embodiments;

FIG. 4 illustrates the systems and/or devices in FIG. 3;

FIG. 5 is a flowchart illustrating a system and method for transferring online sessions in accordance with various embodiments;

FIG. 6 is an illustration of a graphical user interface for transferring online sessions in accordance with various embodiments;

FIG. 7 is an illustration of a graphical user interface for transferring online sessions in accordance with various embodiments; and

FIG. 8 is an illustration of a graphical user interface for transferring online sessions in accordance with various embodiments.

### DETAILED DESCRIPTION

The embodiments presented herein are directed to systems, methods, and computer program products for providing, transferring, analyzing, and processing online account sessions. In some embodiments, a user may log into an online session using trusted devices such as mobile devices that are enrolled or registered with a device identification program. The system allows the user to transfer the online session to another device via wire technology or wireless technology such as near filed communications (NFC), radio frequency identification (RFID), Bluetooth, and the like. The system can receive data from the mobile devices to process transactions, update accounts, and so forth.

The embodiments of the disclosure may be embodied as a system, method, or computer program product. Accordingly, aspects of the present disclosure may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present embodiments of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the disclosure are described below with reference to flowchart illustrations and/or block diagrams of methods, apparatus (systems) and computer program products according to embodiments of the embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

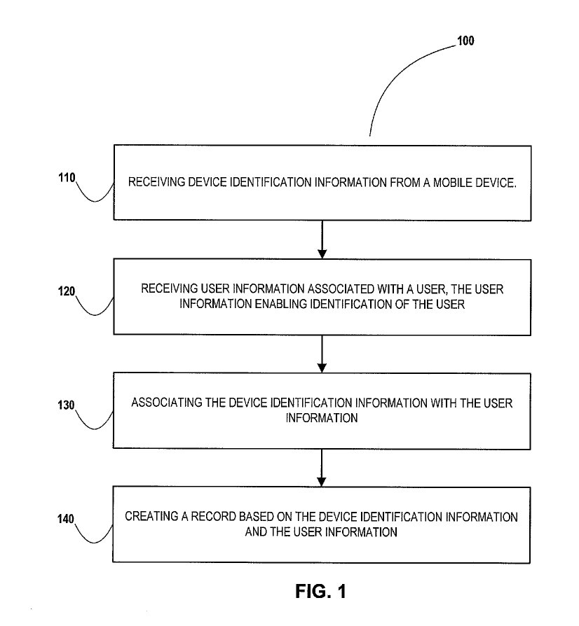

Referring now to FIG. 1, a general process flow 100 is provided for enrolling a user in a device identification program. At block 110, the method comprises receiving device identification information from a mobile device. At block 120, the method comprises receiving user information associated with a user, the user information enabling identification of the user. At block 130, the method comprises associating the device identification information with the user information. At block 140, the method comprises creating a record based on the device identification information and the user information.

The embodiments enable an apparatus (e.g. a computing system) associated with the entity to communicate with the user's mobile device (e.g. smart phone, tablet, or the like). The apparatus collects device identification information and user information from the user's mobile device. The apparatus then binds the device identification information with the user information and creates a record. Ultimately the purpose of the apparatus is to correctly associate the user's identity using device identification information and user information.

After properly downloading and opening the entity's mobile application on the user's mobile device, the apparatus transmits to the device an option to enroll in the device identification program. This option can be accepted or ignored. Acceptance may enable the user to execute certain transactions from the mobile device, including but not limited to logging in, viewing account summaries, requesting account withdrawals, check deposits, and other financial transactions. Acceptance of opting in to the device identification program may be required in continuing enrollment in the device identification program. Furthermore, acceptance of opting in may enable the apparatus to access the device identification information and the user information and may include the transmission, sharing, and storing of this information. Ignoring the option to opt in to the device identification program may require the user to log in on the mobile device using a more time-consuming method of entering a username and a password. Thus, the embodiments save the user time when logging in to the entity's application and eliminate the need to remember and enter a username and a password at every launch of the application on the mobile device. Also, the embodiments presented herein may demand less allocated space on the entity's servers. Utilizing the device identification program eliminates the need to transfer over and store data on the network, which is often typical of checking username and password strings (list of characters, numbers, or the like).

Opting in to the device identification program enables the apparatus to employ a strong authentication process to direct the user throughout enrollment. A strong authentication process is a security measure that requires two or more authentication steps. For example, in a strong authentication process a user may be directed to enter a username, a password, a personal identification number (PIN), a passcode, a biometric (voice) authentication, a fingerprint, a retina scan, or the like, to answer a security question, to transmit device identification information, or the like. The apparatus transmits to the mobile device at least one term or condition associated with the device identification program. In some embodiments, the terms and conditions may be specific to the operation of the device identification program. For example, approving the device identification information terms or conditions may enable the apparatus to collect, transmit, and store information associated with the mobile device. Furthermore, the terms or conditions may address privacy when collecting and storing the device identification information and user information. In other embodiments, the terms and conditions may contain additional information. Acceptance of the terms and conditions of the device identification program may be required to continue through enrollment in the device identification program.

The apparatus gathers device identification information to generate a device “fingerprint,” or unique signature of the user's mobile device. Device identification information may be collected from a variety of sources. In some embodiments the device identification information comprises an identification code. The identification code may include but is not limited to a serial number or an item number of the device. In some embodiments, the device identification information may be associated with a chip associated with the mobile device. The chip may be but is not limited to a subscriber identification module (SIM) card, removable hard drive, processor, microprocessor, or the like. In other embodiments, the device identification information may be associated with a removable part of the mobile device. Removable parts include but are not limited to detachable keyboards, battery covers, cases, hardware accessories, or the like. Removable parts may contain serial numbers or part numbers.

In some embodiments, device identification information may need to be entered manually at the mobile device. For example, if the apparatus is unable to locate the mobile device's serial number automatically (perhaps due to interference, long range, or similar hindrance), the apparatus may prompt the user for manual entry of the serial number (or an identification code, an International Mobile Station Equipment Identity (IMEI), a phone number, a chip, a removable part, or similar pieces of device identification information). In other embodiments, device identification information may not be based on user input received at the mobile device. Instead, the apparatus may automatically collect the device identification information. Once discovered by the apparatus, the device identification information is transmitted from the mobile device to the apparatus. This information is stored in memory of the apparatus.

Location information may be necessary to the apparatus's functionality. The apparatus may use location information to determine the location of the user's mobile device. This may be pertinent if certain executable transactions (fund withdrawals, fund deposits, fund transfers, account summaries, or the like) are to be contained within a defined radius of one of the entity's facilities, a regular location (the user's residence, workplace, or any other place that is visited by the user more than a predetermined number of times during a certain period of time), or the like. In some embodiments, location information is recorded and analyzed to determine the habits of the user. Location information is based on a location associated with the mobile device at the time of the initiation or execution of the application on the mobile device. In some embodiments, the apparatus may prompt the user to enable access to the location of the mobile device during the strong authentication process. In other embodiments, the user may enable access to the location of the mobile device through settings, preferences, network, privacy, options, or similar menus.

Following the successful collection of device identification information, the apparatus may collect user information. In some embodiments, the user information is collected after the device identification information and/or location information. In some embodiments, the user information is collected before the device identification information and/or location information. In other embodiments, the user information, the device identification information, and/or location information are collected substantially simultaneously.

The apparatus collects a wide array of user information to prove the identity of the user. In some embodiments, the user information includes but is not limited to at least one of a name, contact information, a username, a password, social network information, an account number, or a card number. In some embodiments, user information can be comprised of an account associated with the user, a unique identification number associated with the user, or the like. In some embodiments, the user information may be proprietary to the entity, such as an account number, a reference number to an account, a client number, or the like. In other embodiments, the user information may be public information, such as a phone number, mailing address, email address, or the like.

The apparatus may automatically retrieve the user information from the user's mobile device. In some embodiments, the user information is collected and transmitted with no human interaction. In other embodiments, the user information is unable to be automatically retrieved by the apparatus. The apparatus may prompt the user to manually enter the user information necessary to continue enrollment. For example, the user may be a new customer and therefore be prompted by the apparatus to register for a new account, complete fields of user information, or complete similar actions on the mobile device. The user may manually enter the user information on the mobile device necessary to continue enrollment. The collected user information is stored in memory on the apparatus.

With the device identification information and the user information in memory, the apparatus is further configured to determine the identity of the user and associate the user with a customer account. The apparatus locates the records in memory that are associated with the device identification information by searching the databases for matching parameters. As described above, the device identification information relates to the unique signature of the mobile device. The device identification information may include but is not limited to an identification code, a serial number, removable parts, a chip, a SIM card, user input, or the like. Additionally or simultaneously, the apparatus locates the records in memory that are associated with the user information by searching the databases for matching parameters. As described above, the user information may relate to a name, contact information, a username, a password, social network information, an account number, a card number, user input, or the like. In some embodiments, the user information may refer to a customer account with the entity. In some embodiments, the user information may refer to a customer account with a partner entity, wherein the data is accessible. In other embodiments, the user information may refer to a customer account with no partner entities and may not be accessible by the apparatus without further consent from the host of the user information.

Successful location of the device identification information and the user information in memory enables the apparatus to identify the user based on the information associated with the account. The apparatus may use a combination of the device identification information and the user information to determine the identity of the user. For example, if the user's address is located in Charlotte, N.C. and the apparatus determines that the user's request is stemming from a mobile device, IP address, or cell tower in Charlotte, N.C., then the apparatus may confirm that the user is indeed correctly identified. Further authentication may or may not be necessary. Conversely, if the user's address is located in Charlotte, N.C. and the apparatus determines that the user's request is stemming from Boston, Mass., then the apparatus may or may not confirm that the user is indeed correctly identified. Further approval or authentication may be required to associate the user's request with an existing customer account. In some embodiments, the apparatus creates a strong binding between the user information and the device information to positively associate the user's customer account with the mobile device. Once the association is made, the apparatus makes a record in memory of the bound association for future reference.

In some embodiments, the user may not be required to input a username or a password when logging in to the entity's application. Instead, the apparatus may automatically collect the necessary information (device identification information and user information) to positively identify the associated user and mobile device. Successful binding of the user's customer account and the mobile device may enable the user to execute certain transactions on the mobile device such as transferring online session as described below. In other embodiments, the user may be required to input additional information to authenticate the device identification program. This may include manual entry of the device identification information or manual entry of the user information. For example, the user may be required to enter a username, a password, a PIN number, an answer to a security question, a passcode, a biometric (voice, fingerprint, retina scan, or the like) authentication, or a similar security measure to gain access into the entity's application, complete a transaction, gain access to more advanced transaction types, change settings, preferences, or similar options, or the like. As used herein, the “PIN” may refer to any and all types of security prompts, including but not limited to a username, a password, a PIN, an answer to a security question, a passcode, a biometric (voice, fingerprint, retina scan, or the like) authentication, or a similar security measure. The entity may reserve the right to determine which type of security prompt may be presented to the user at any level of security.

Upon successful enrollment, the apparatus may be configured for normal use. Initiation of the application opens and starts the application on the mobile device. Once running, the application may send to the apparatus the device identification information and the user information. In some embodiments, the device identification information is transmitted to the apparatus before the user information. In some embodiments, the device identification information is transmitted to the apparatus after the user information. In other embodiments, the device identification information and the user information are transmitted to the apparatus simultaneously. Once transmitted, the apparatus receives the device identification information and the user information and records both in memory. The apparatus may search a database of customer account records based on the device identification information and the user information. This associates the device identification information and the user information with the correct user and mobile device. Thus, in response to determining a match between the received device identification information, the received user information, and the record of the user's customer account and mobile device, the apparatus may enable the user to access to the functionality of the application. In some embodiments, the apparatus may enable the user to access to all transactions on the mobile device. In some embodiments, the apparatus may enable the user to access a selected group of transactions on the mobile device. In other embodiments, the apparatus may require additional security measures to enable access to all transactions on the mobile device.

The device identification program may depend on network connectivity, network speeds, network congestion, signal interference, or the like. In some embodiments, unexpected errors may occur during normal installation, operation, or transactions. Potential errors may include but are not limited to run time errors, network connectivity errors, slow network speed errors, network congestion, poor reception, signal interference, dropped packets of information, or the like.

Additionally, the embodiments may or may not be limited to the financial domain. The embodiments may be highly applicable to other industries and digital services. Any service that requires a username or a password login may benefit from the device identification program. Example beneficiaries outside of the financial domain include but are not limited to social media platforms, email platforms, investment platforms, telecommunications platforms, developer platforms, music services, application stores, or the like.

The apparatus provides or hosts a digital financial service application for mobile device users. Within the application, transactions may include but are not limited to fund withdrawals, account summaries, fund deposits, fund transfers, service requests, creating an account, closing an account, contacting a service assistant, or the like. The apparatus may be created to save the user time and hassle when starting the application and executing financial transactions.

The apparatus interacts with a mobile device that exists as a means of communication between the user and the entity. In some embodiments, the mobile device may be a handheld computing device (laptop, personal digital assistant (PDA), cell phone, smart phone, tablet, mp3 player, chip, or any other electronic device). In other embodiments, the mobile device may be a computer processor (or similar electronic component) that is embedded in existing systems. Examples of an embedded computer processor may be found on satellites, underneath human skin, or the like. In alternate embodiments, the mobile device may comprise or be integrated into a motor vehicle. In other alternate embodiments, the “mobile device” may refer to a non-mobile or non-portable computing device (e.g. a desktop computer, a kiosk, or the like).

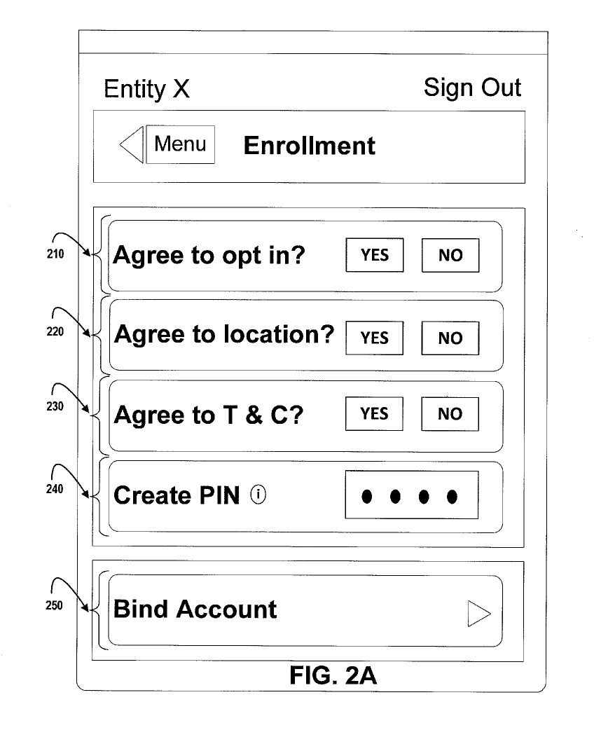

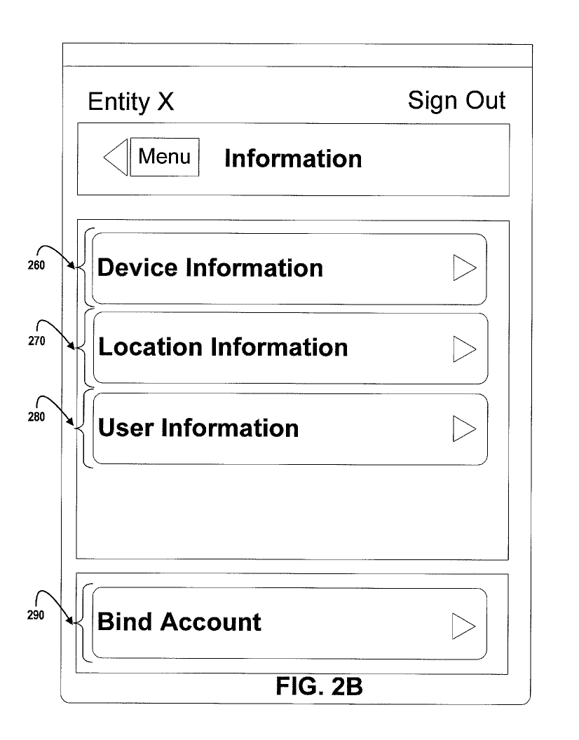

Referring now to FIG. 2A, FIG. 2A presents a user interface that is presented to the user when the user launches the application to begin the enrollment process, in accordance with some embodiments of the invention. If the user wishes to enroll in the device identification program, the user must agree to opt in 210 to the device identification program. Agreeing to opt in to the device identification program may unlock the options that follow. The user may be required to opt in to the device identification program to continue enrollment. If the user wishes to enable the apparatus to determine the location of the user's mobile device via global positioning system (GPS) coordinates, an IP address, or cell tower location, the user must agree to provide location information 220. The location information may aid in associating the correct device identification information with the user. Thus, the location information may be critical in binding the mobile device to the user's customer account. If the user wishes to continue enrolling in the device identification program, then the user must agree to the Terms or Conditions 230 of the device identification program. Agreeing to the Terms or Conditions may be required to continue through enrollment in the device identification program. The Terms or Conditions may provide an outline of the rules and regulations associated with the device identification program including but not limited to discussions of privacy, operation, contract length, construction, device usage, or the like. If the user wishes to be granted full access to all transaction types and options of the application, the user may create a four-digit PIN 240. This PIN may serve as an additional layer of security that protects the premium features and transactions of the application. An information tab explaining the significance of the PIN may be featured next to the entry field. The user may select “Bind Account” 250 after the above fields have been completed. The “Bind Account” 250 tab initiates the search of records to associate the device identification information and the user information with the user's customer account.

Referring now to FIG. 2B, FIG. 2B presents a user interface that is presented to the user in the event that the apparatus was unsuccessful in positively associating the device identification information and the user information. An unsuccessful binding of the user's customer account to the provided device identification information and user information may be a product of several embodiments. In some embodiments, the apparatus may not have received the device identification information from the mobile device. In some embodiments, the apparatus may not have received the user information from the mobile device. In other embodiments, the apparatus may have received an inadequate amount or a rejected combination of device identification information or user information. Potential errors have been discussed above and include but are not limited to network issues, telecommunication issues, being out of range of the network, or the like. In the event that the binding of the user's customer account and the device identification information and the user information, the user interface presented in FIG. 2B will direct the user to manually troubleshoot the issue. Selecting the “Device Information” 260 tab may present to the user a form that enables the user to manually enter information associated with the device. Examples of device identification information are presented more thoroughly above and include but are not limited to identification codes, serial numbers, chips, removable parts, hardware accessories, user input, or the like. Selecting the “Location Information” 270 tab may present to the user a form that enables the user to manually enter information associated with the location of the user and the user's mobile device. Examples of location information are presented more thoroughly above and include but are not limited to GPS coordinates, a residential address, a work address, a shipping address, a zip code, or the like. Selecting the “User Information” 280 tab may present to the user a form that enables the user to manually enter information associated with the user. Examples of user information are presented more thoroughly above and include but are not limited to a name, contact information, a username, a password, social network information, an account number, a card number, user input, or the like. Selecting the “Bind Account” 290 tab initiates the search of records to associate the device identification information, location information, and the user information with the user's customer account.

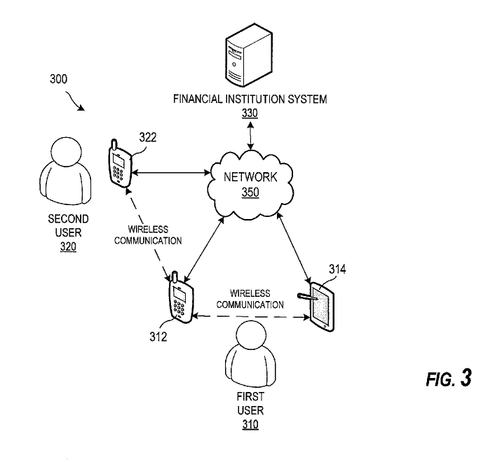

Referring now to FIG. 3, a block diagram illustrating a system and environment 300 for providing, transferring, and analyzing online sessions is provided. Included in the figure are a financial institution system 330, a first user 310, a first computing device 312 of the first user 310, a second computing device 314 of the first user 310, a second user 320, and the computing device 322 of the second user 320. The financial institution system 330 and computing devices 312, 314, 322 are in communication with each other via network 350. Although the illustrated embodiment includes a financial institution system and three user computing devices, it will be understood that any number of systems and devices can be included in the environment 300. The user computing devices 312, 314, 320 include, for example, mobile devices, laptops, gaming devices, personal digital assistants, personal computers, and so forth. In some embodiments, the user computing devices 312, 314, 320 include mobile devices such as cellular telephones, smart phones, tablets, and the like.

In the illustrated embodiment, the first user 310 logs into an application using the computing device 312 or computing device 314. In some embodiments, the first user 310 and/or second user 320 enrolls or registers their device(s) with a device identification program as detailed above. The financial institution system 330, in some embodiments, maintains online accounts of the first user 310 and/or second user 320, maintains financial accounts of the first user 310 and/or second user 320, provides the mobile application associated with the online accounts, or combinations thereof.

The first user 310 launches a mobile application to initiate an online session on the computing device 312 or 314. In some embodiments, the first user 310 transfers the online session to the second computing device 314 via wireless communication technology. For example, if the user 310 desires a larger screen to view the online session or input data, the user 310 may “bump” the computing device 312 to the computing device 314 and transfer the online session via NFC (near field communication). In such cases, the first computing device 312 and the second computing device 314 may each have an application for initiating the online session stored in local memory, streamed from the financial institution system 330, or otherwise associated with the computing device 312, 314, 322. The system 300 can then detect whether or not the second computing device 314 has control over the online session. As further illustrated in FIG. 3, the first user 310 may also transfer the online session to the second user's computing device 322. In some examples, the first user 310 and second user 320 may be joint account owners. If the computing device 312 is running low on batteries, for example, the first user 310 may transfer the online session to the second user's computing device 322 in order to complete a transaction, upload a check image for a deposit, move money between accounts, and the like.

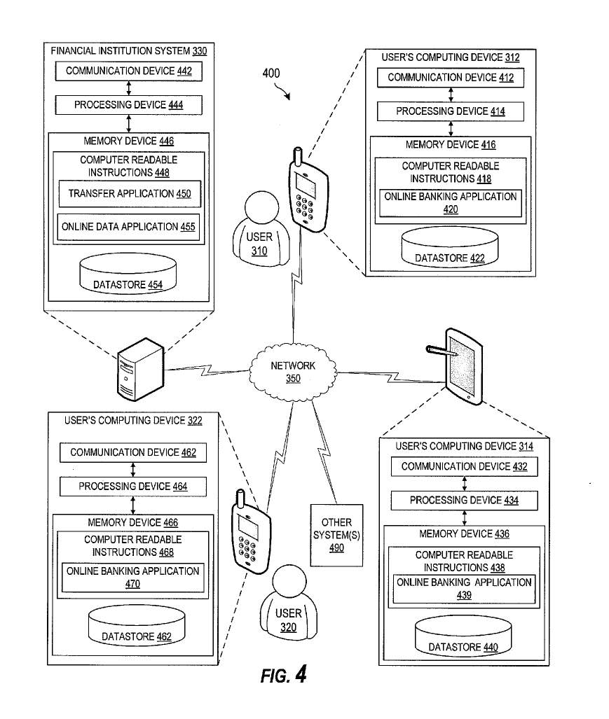

Referring now to FIG. 4, a block diagram illustrates an environment 400 for transferring online session. The environment 400 includes the first user's first computing device 312, the first user's second computing device 314, the second user's computing device 322, and the financial institution system 330 of FIG. 3. The environment 400 further includes one or more other systems 490 (e.g., a partner, agent, contractor, other user, third party systems, external systems, internal systems, and so forth). The systems and devices communicate with one another over the network 350 and perform one or more of the various steps and/or methods according to embodiments of the disclosure discussed herein.

The first user's first computing device 312, the first user's second computing device 314, the second user's computing device 322, and the financial institution system 330 each includes a computer system, server, multiple computer systems and/or servers or the like. The financial institution system 330, in the embodiments shown has a communication device 442 communicably coupled with a processing device 444, which is also communicably coupled with a memory device 446. The processing device 444 is configured to control the communication device 442 such that the financial institution system 330 communicates across the network 350 with one or more other systems. The processing device 444 is also configured to access the memory device 446 in order to read the computer readable instructions 448, which in some embodiments includes a transfer application 450 and an online data application 455. The memory device 446 also includes a datastore 454 or database for storing pieces of data that can be accessed by the processing device 444. In some embodiments, the datastore 454 includes online session data such as transaction data, user input, and device tracking data, as well as login data, device registration data, user data, and the like.

As used herein, a “memory device” generally refers to a device or combination of devices that store one or more forms of computer-readable media and/or computer-executable program code/instructions. Computer-readable media is defined in greater detail below. For example, in one embodiment, the memory device 446 includes any computer memory that provides an actual or virtual space to temporarily or permanently store data and/or commands provided to the processing device 444 when it carries out its functions described herein.

The first user's computing device 312 includes a communication device 412 communicably coupled with a processing device 414, which is also communicably coupled with a memory device 416. The processing device 414 is configured to control the communication device 412 such that the first user's computing device 312 communicates across the network 350 with one or more other systems. The processing device 414 is also configured to access the memory device 416 in order to read the computer readable instructions 418, which in some embodiments includes an online banking application 420. The memory device 416 also includes a datastore 422 or database for storing pieces of data that can be accessed by the processing device 414.

The first user's second computing device 314 includes a communication device 432 communicably coupled with a processing device 434, which is also communicably coupled with a memory device 436. The processing device 434 is configured to control the communication device 432 such that the second user's computing device 322 communicates across the network 350 with one or more other systems. The processing device 434 is also configured to access the memory device 436 in order to read the computer readable instructions 438, which in some embodiments includes an online banking application 439. The memory device 436 also includes a datastore 440 or database for storing pieces of data that can be accessed by the processing device 434.

The second user's computing device 322 includes a communication device 462 communicably coupled with a processing device 464, which is also communicably coupled with a memory device 466. The processing device 464 is configured to control the communication device 462 such that the second user's computing device 322 communicates across the network 350 with one or more other systems. The processing device 464 is also configured to access the memory device 466 in order to read the computer readable instructions 468, which in some embodiments includes an online banking application 470. The memory device 466 also includes a datastore 462 or database for storing pieces of data that can be accessed by the processing device 464.

In some embodiments, the online banking application 420 and/or the online banking application 439 interact with the transfer application 450 and/or online banking application 470 to transfer online sessions to clients and/or systems associated with the computing devices 312, 314, 322.

The applications 420, 439, 450, 455, and 470 are used for instructing the processing devices 414, 434, 444 and 464 to perform various steps of the methods discussed herein, and/or other steps and/or similar steps. In various embodiments, one or more of the applications 420, 439, 450, 455, and 470 are included in the computer readable instructions stored in a memory device of one or more systems or devices other than the system 330 and the users' computing devices 312, 314, 322. For example, in some embodiments, the application 420 is stored and configured for being accessed by a processing device of one or more third party systems (e.g., the other systems 490) connected to the network 350. In various embodiments, the applications 420, 439, 450, 455, and 470 are stored and executed by different systems/devices are different. In some embodiments, the applications 420, 439, 450, 455, and 470 are stored and executed by different systems may be similar and may be configured to communicate with one another, and in some embodiments, the applications 420, 439, 450, 455, and 470 may be considered to be working together as a singular application despite being stored and executed on different systems.

In various embodiments, one of the systems discussed above, such as the financial institution system 330, is more than one system and the various components of the system are not collocated, and in various embodiments, there are multiple components performing the functions indicated herein as a single device. For example, in one embodiment, multiple processing devices perform the functions of the processing device 444 of the financial institution system 330 described herein. In various embodiments, the financial institution system 330 includes one or more of the external systems and/or any other system or component used in conjunction with or to perform any of the method steps discussed herein. For example, the financial institution system 330 may include a financial institution system, a credit agency system, and the like.

In various embodiments, the financial institution system 330, the second user's computing device 322, and the first users' computing devices 312, 314 and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 500, the other methods discussed above, or other methods, processes or steps discussed herein or not discussed herein.

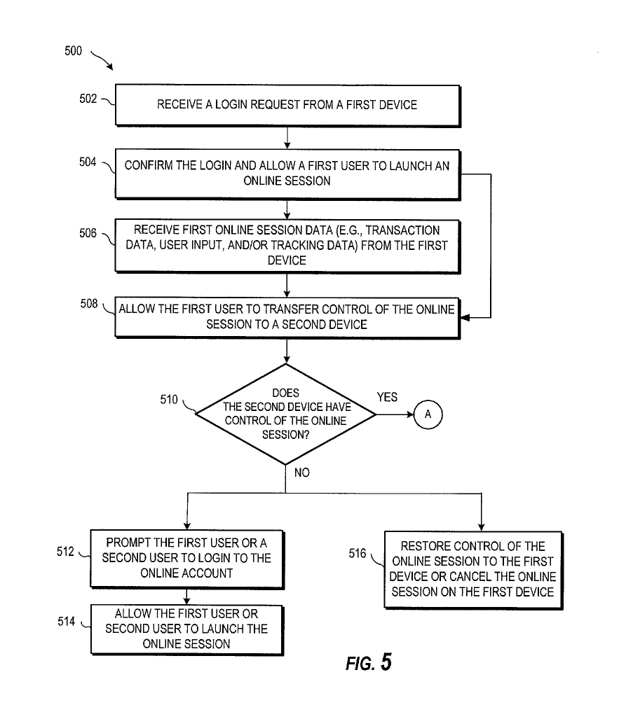

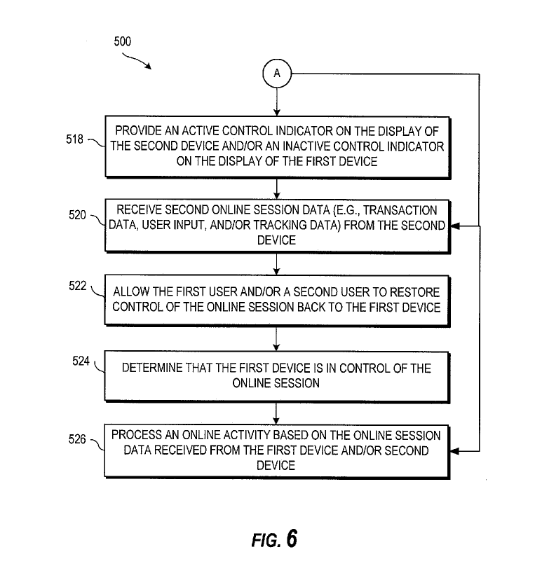

FIGS. 5-6 illustrate a flowchart that provides an overview of a process 500 for providing online accounts, transferring online sessions, and processing online activity. One or more devices, such as the one or more devices and/or one or more other computing devices and/or servers of FIGS. 3-4, can be configured to perform one or more steps of the process 100 described above or 500 described below. In some embodiments, the one or more devices performing the steps of the processes are associated with a financial institution. In other embodiments, the one or more devices performing the steps of the processes are associated with a merchant, business, partner, third party, credit agency, account holder, and/or user. As provided herein, it will be understood that the process of FIG. 5 is merely an exemplary embodiment and that the various steps of process 500 can be conducted in any order.

As illustrated at block 502, a login request is received from a first device. The login request, in some embodiments, comprises the device information, user information, and/or enrollment information detailed above. For example, the login request may include a transmission from the first device that indicates that the device is a device that has previously successfully enrolled in the device identification program discussed above. In other cases, the login request may include an enrollment request for enrolling in the device identification program. The login request can further include user input such as a PIN, device identifier, user name, security answers, biometric data, and so forth.

As illustrated at block 504, the login is confirmed. For example, the system of process 500 may match credentials in the login request with credentials assigned to a trusted device. In further examples, the login may be confirmed by prompting and receiving input from the user such as passwords, security codes, biometric data, IP addresses, and the like. In other embodiments, a first user is allowed to launch an application to initiate an online session. In some embodiments, the online session comprises online accounts session. As used herein, “user” includes account holders, agents of account holders, parties to an agreement, account customers, purchasers, or any other entity authorized to access at least a portion of an online account.

As illustrated at block 506, first online session data is received from the first device. In some embodiments, the first online session data includes transaction data, user input, device tracking data, account data, and the like. Exemplary first online session data includes purchase amounts, purchases dates, transaction channels, account numbers, account types, inbound and outbound amounts, account balance amounts, types of transactions, number of transactions, geographical location data, location coordinates, and the like.

As illustrated at block 508, the first user is allowed to transfer control of the online session to a second device. In some embodiments, the first device and/or the second device comprise mobile devices such as smart phones, tablets, and the like. The second device may be associated with the first user and/or a second user. The first device and/or the second device can be used or owned by the first user and/or second user. In one example, the first user uses both the first device and the second device to access the online account and initiate the online session. In other examples, the first user uses the first device to initiate the online session and transfer control of the online session and the second user uses the second device to receive control of the online session.

The first user may desire or need to transfer control of the online session for any number of reasons. The first user may transfer the online session due to limited battery life on the first device, device hardware malfunctions, software malfunctions, device input and output shortcomings (e.g., small display area, lack of keyboard, mouse, camera, or speakers), limited network coverage, security concerns such as inputting sensitive information in a public area or via an unsecured network, timing issues (e.g., the first user is currently busy or does not have enough information to proceed), and the like. Further, the first user may not have the time, resources, or credentials to complete an action and may desire or require that a second user complete an action. Online session related to agreements, contracts or other negotiating devices, purchases, deposits, payments, transfers, authorization, and the like may require action from a second user.

The first user can transfer control of the online session to the second device using wireless technology. Exemplary wireless communication technology includes radio Wi-Fi, Bluetooth, RFID, NFC, and the like. The first user may, for example, “bump” the first and second devices together to transfer control on the online session using NFC enabled devices. In such cases, the first device and second device may be in the same geographic area. Other wireless technology may be used in situations where the first device and second device are in separate geographic areas. In some embodiments, the online application on the first device communicates with an online application on the second device to initiate the transfer of the online session to the second device. The user of the second device may be prompted to allow initiation of the transfer or may be notified that transfer has occurred. In specific embodiments, the user of the second device is prompted to enter a PIN or other credentials to sign into the online account to receive control of the online session. In other embodiments, the second device automatically receives control of the online session. For example, the system of process 500 may automatically determine that the second device is a registered device or is otherwise a trustworthy device during the transfer process.

In additional embodiments, the first device is logged out of the online session upon successful transfer of the online session or upon initiation of the transfer. In other embodiments, the first device remains logged into the online session. In such cases, the first device and second device may each have full or limited control of the online session. For example, the first device may be placed in an inactive control mode and the second device may be placed in an active control mode as described in more detail below.

As illustrated at decision block 510, a determination as to whether the second device has control of the online session is provided. In some embodiments, determining whether or not the second device has control of the online session is based on transmissions received from the first device and/or second device. For example, if the first device ceases to transmit device tracking data, if the first device transmits data indicating that control has been transferred, and/or if the second device transmits data indicating that control transfer has failed or been successful, the system may determine that the transfer of the online session to the second device occurred or failed to occur.

In other embodiments, determining whether or not the second device has control of the online session is based on enrollment or registration data. As disclosed above with reference to FIGS. 1, 2A, and 2B, the user of the first or second device can enroll or register devices by submitting device and user information. In some cases, the second device may be denied control of the online session if credentials of the device do not match enrollment records stored in a database, or the second device may be allowed to receive control of the online session if a match is found. In cases where there is no match, the second device may be prompted to enroll or register the device before proceeding. In other cases, as described below, the second device may be denied access to the online session if it is determined that the second device is not a registered device.

As illustrated at block 512, the user of the second device (whether the first user or a second user) is prompted to login to the online account in response to determining that the second device does not have control of the online session. For example, if the second device does not receive control of the online session due to issues with the communication technology or device, or if the second device is not a registered device, the first user or the second user may need to sign into the online account. The system of process 500 can then confirm the login and allow the first user or the second user to launch the application to initiate the online session as illustrated at block 514.

Additionally or alternatively, as illustrated at block 516, control of the online session is restored to the first device in response to determining that the second device does not have control of the online session. In other embodiments, the first device may retain control or stay logged into the online session until the second device is in control of the online session. In still other embodiments, the online session is cancelled on the first device. For example, the first user or the second user may be required to log into the online account on the second device, which may cause the first user to be logged out of the online account on the first device.

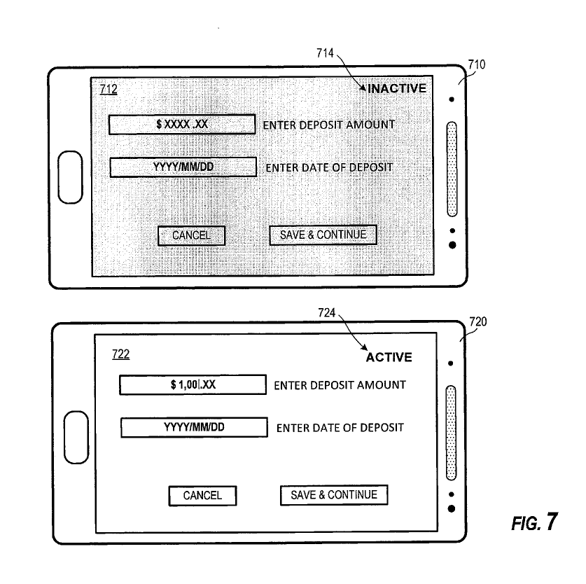

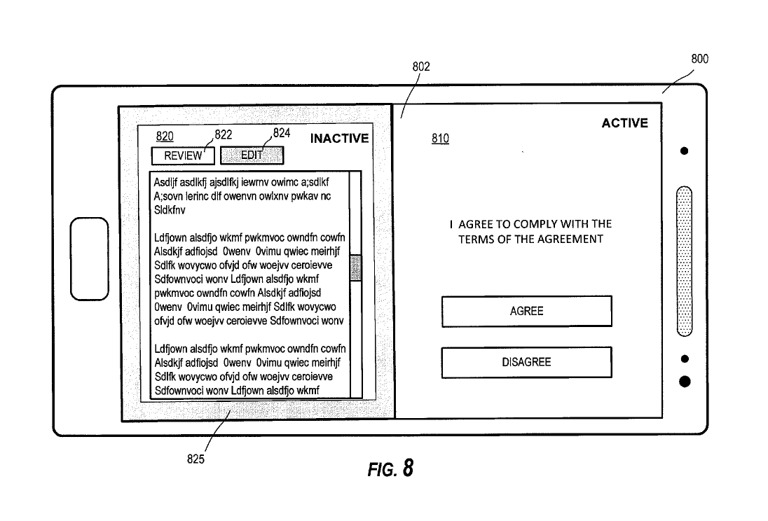

Referring now to FIG. 6, the process 500 is further illustrated. As illustrated at block 518, an active control indicator is provided on the display of the second device and/or an inactive display indicator is provided on the display of the first device. The visual indicators allow the first user and/or second user to quickly determine if they have control of the online session. Exemplary indicators are provided in FIGS. 7-8 and are described in more detail below. It will be understood that the transferred online session described herein can be further enhanced via text, voice, and video communications.

In some embodiments, the online session on the first device is set to an inactive control mode in response to the first user's transfer of control of the online session or when it is determined that the transfer of control to the second device is successful. In the inactive control mode, account features such as fields, screens, menus, buttons, access authorizations, and tools associated with the online session can be limited such that the first user of the first device can only perform certain actions. In some examples, the user may be unable to change screens, input data in one or more fields, modify data, and the like.

In additional embodiments, access parameters of the inactive control mode are based on user preferences, account status, account type, security features, user actions, the identity of the first user or second user, and combinations thereof. In some cases, the first user may have full access to portions of the online account that are not currently being accessed by a user of the second device. For example, if a second user of the second device is inputting sensitive information, the first user may be prevented from accessing that portion of the online account in the inactive control mode. In other examples, a joint account holder may be able to redeem rewards and update a billing address on one mobile device while another joint account holder reviews a billing statement to confirm that it is correct. In still other cases, the first user may be able to view the screen of the second device and follow a second user's action on the first device using a split screen (e.g., see FIG. 8). In further examples, the first user may set the portions of the online account that can be accessed and the user actions that can be performed on the device receiving control of the online session. For example, an account holder may only want their agent to access a payment portal page for inputting a credit card number, security code, and may not want the agent to view other purchase data or other portions of the online account during the online session. In other embodiments, they system of process 500 automatically sets access parameters for the inactive control mode. For certain types of accounts such as mutual fund accounts or certain types of actions such as bill pay, the system can automatically limit the tools, buttons, fields, pages, and other features that a second user on the second device can access.

In other embodiments, the online session is set to an active control mode on the second device when it is determined that the transfer of control to the second device is successful. In some embodiments, the user of the second device may be given full control of the online session in the active control mode. In other embodiments, fields, screens, menus, buttons, access authorizations, and tools associated with the online session can be limited such that the user of the second device can only perform certain actions. The access parameter of the active control mode can be based on the identity of the user of the second device. For example, the system of process 500 may prompt the user of the second device to input a PIN in order to determine if it matches credentials of the first user or an authorized user. If the first user of the first device is also the user of the second device, the active control mode may allow the first user full access to the features of the online account. In other examples, accounts having only a single authorized account holder may not allow a second user of the second device to view or change passwords, initiate outbound transactions, or move money while accounts having multiple authorized agents may allow the agents to access more features of the online account when they have active control.

As illustrated at block 520, second online session data is received from the second device. As noted above, online session data includes purchase amounts, purchases dates, transaction channels, account numbers, account types, inbound and outbound amounts, account balance amounts, types of transactions, number of transactions, geographical location data, location coordinates, and the like. For example, the online session may be transferred from the first device to the second device using NFC at a first location, but the second device may relocate to other locations during the online session. Further, the first user or second user may input additional data or modify data on the online account during the online session.

As illustrated at block 522, the first user and/or second user is allowed to restore control of the online session back to the first device. As described hereinabove, the transfer of control from one device to another can occur through various wireless communication technologies and for any number of reasons. In some embodiments, the control indicator associated with each of the first device and the second device is modified in response to the transfer. For example, the system of process 500 may provide an inactive control indicator on the display of the second device and an active control indicator on the display of the first device. In other embodiments, the online session on the second device is cancelled. For example, the second device may be logged out of the online account when the first device retains control of the online session. Although the embodiments illustrated in FIGS. 5-6 describe transfers between two devices, it will be understood that any number of devices may be used and any number of online session transfers may be undertaken. For example, the first device or second device may transfer control of the online session to at least another device, and the online session may be transferred between the two or more device any number of times.

As illustrated at block 524, it is determined that the first device is in control of the online session. As described hereinabove, transmission from the first device and/or second device may be used to make the determination. In situations where the first device does not regain control of the online session, the first user may be prompted to log back into the online account.

As illustrated at block 526, an online activity is processed based on the first online session data received from the first device and/or the second online session data received from the second device. The system of process 500 may provide calculations, authorization, transfers, communications, research, analysis, archival, and other actions related to the online activity. Exemplary online activity includes purchases, account updates, user updates, balance transfers, deposits, payments, contract renewals, agreement modifications, reward offer retrieval, product reviews, and the like.

Referring now to FIGS. 7-8, exemplary graphical user interfaces (GUIs) of mobile devices used to transfer online session are illustrated. In FIG. 7, a first mobile device 710 displaying a GUI 712 and a second mobile device 720 displaying a GUI 722 is provided. In the illustrated embodiment, the first mobile device 710 has transferred control of the online session to the second mobile device 720. The GUI 712 includes a control indicator 714 that designates the online session on the first mobile device 710 to be “inactive.” Moreover, the user of the first mobile device 710 is prevented from taking action in the inactive control mode as indicated by the greyed out, non-functional buttons, fields, and background in GUI 712. The GUI 722, on the other hand, display a control indicator 724 that designates the online session on the second mobile device 720 to be “active.” In other embodiments, the control status of the online session for the mobile device 710 or mobile device 720 is indicated using text, signs such as an X or a check mark, color coded symbols, and the like.

In the illustrated embodiment, the displays on the mobile devices 710 and 720 present the same screen, but the GUI 712 does not display the actions that are taking place in the online session on the second mobile device 720 in real time. The user of the second mobile device 720 is typing in a deposit amount if the designated field, but the user input is not on display in the GUI 712. The GUI 712 may remain frozen on the screen that was in place when the transfer was initiated such that when a user of the mobile device 720 goes to another screen, the user of the mobile device 710 may not be able to view the new screen. In other cases, updates to the online session on the mobile device 710 may be infrequent and lag behind updates on the mobile device 720.

In further embodiments, the user of the first mobile device 710 or the user of the second mobile device 720 communicates during the online session via text, video, or voice technologies. For example, if the users of the mobile device 710 and 720 can video chat during the online session to clarify terms of an agreement, review account balances, or the like. In this way, the online session experience of the users of the mobile device 710 and 720 is further enhanced.

FIG. 8 includes a mobile device 800 displaying a split screen 802. The split screen 802 includes an inactive portion 820 and an active portion 810. A highlighted border 825 indicates that the inactive portion 820 is associated with the mobile device 800. In this way, the user of the mobile device 800 can easily determine that he or she has the ability to manipulate the inactive portion 820 on the left hand side of the split screen 802 and the non-bordered screen is associated with another device. In the illustrated embodiment, the user can view the actions occurring on both the mobile device 800 and another mobile device that is in control of the online session. In some embodiments, the actions occurring on the other mobile device (indicated by active portion 810) is updated in real time. In other embodiments, the actions occurring on the active portion 810 device lags behind the actions occurring in real time on device 800. In still other embodiments, the actions occurring or features in active portion 810 is different from the display of the other mobile device. In situations where the user of the other mobile device is a non-English speaker, for example, the text appearing on the display of the other mobile device that has active control of the online session may be quite different than the text appearing in the active portion 810 that is being presented to the user of mobile device 800. Although the embodiment in FIG. 8 is directed to a mobile device that has transferred control of the online session to another device, it will be understood that the other device that is currently in control of the online session may also include a split screen display.

In some embodiments, the online session is set to an inactive control mode. As shown in FIG. 8, the inactive portion 820 includes an active button 822 and an inactive button 824. While in the inactive control mode, the user of mobile device 800 is only be able to review a contract and is not able to edit the contract. In other examples, the user may be unable to change screens, input data in one or more fields, modify data, and the like.

In additional embodiments, the online session is set to an active control mode. Active portion 810 shows the screen of a second device that is in active control mode. In the illustrated embodiment, the active control mode allows the user of a second device to use all of the buttons in the active portion 810. In some embodiments, the user of the second device may be limited to the agreement screen shown in active portion 810, or the user of the second device may be allowed greater access to the online account during the online session.

To supplement the present disclosure, this application further incorporates entirely by reference the following commonly assigned patent applications: U.S. patent application Ser. No. ______ for a “Remote Control for Online Banking,” filed Jul. 19, 2013, attorney docket number 5752US1.014033.1939; U.S. patent application Ser. No. ______ for “Online Banking Alerts,” filed Jul. 19, 2013, attorney docket number 5787US1.014033.1952; U.S. patent application Ser. No. ______ for “Customer-Defined Online Banking Access Restrictions,” filed Jul. 19, 2013, attorney docket number 5788US1.014033.1953; U.S. patent application Ser. No. ______ for “Restricted Access to Online Banking,” filed Jul. 19, 2013, attorney docket number 5788US2.014033.1954; U.S. patent application Ser. No. ______ for “Offline Mobile Banking,” filed Jul. 19, 2013, attorney docket number 5791US1.014033.1955; U.S. patent application Ser. No. ______ for “Completing Mobile Banking Transactions from Trusted Location,” filed Jul. 19, 2013, attorney docket number 5792US1.014033.1956; U.S. patent application Ser. No. ______ for “Completing Mobile Banking Transaction with Different Devices,” filed Jul. 19, 2013, attorney docket number 5792US.014033.1957; and U.S. patent application Ser. No. ______ for “Systems for Managing Account Aggregators Access to Financial Account Information,” filed Jul. 19, 2013, attorney docket number 5794US1.014033.1960.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. The following claims are in no way intended to limit the scope of embodiments of the disclosure to the specific embodiments described herein.

What is claimed is:

1. A system for transferring online account sessions, the system comprising:
a computer apparatus including a processor and a memory; and
a transfer software module stored in the memory, comprising executable instructions that when executed by the processor cause the processor to:
allow a first user to launch an account session on a first mobile device via an application stored on the first mobile device;
receive first session data from the first mobile device, the first session data comprising at least one of transaction data, user input, and device tracking data;
allow the first user to transfer control of the account session from the first mobile device to a second mobile device; and
determine whether or not the second mobile device has control of the account session based on transmission data received from the first mobile device or second mobile device.

2. The system of claim 1, wherein the executable instructions further cause the processor to:
determine that the second mobile device has control of the account session;
receive second session data from the second mobile device; and
process an online activity based on the first action session data or the second action session data,
wherein the online activity comprises at least one of inbound transactions, outbound transactions, and account updates.

3. The system of claim 2, wherein the executable instructions further cause the processor to:
allow the first user or a second user to return control of the account session from the second mobile device back to the first mobile device; and
determine that the first mobile device is in control of the account session.

4. The system of claim 2, wherein the executable instructions further cause the processor to:
cancel the account session on the first mobile device upon determining that the second mobile device has control of the account session; or
set the account session on the first mobile device to an inactive control mode upon determining that the second mobile device has control of the account session.

5. The system of claim 1, wherein the executable instructions further cause the processor to:
determine that the second mobile device does not have control of the account session; and
prompt a user of the second mobile device to register the second mobile device upon determining that the second mobile device does not have control of the account session,
wherein the user of the second mobile device comprises the first user or a second user.

6. The system of claim 5, wherein the executable instructions further cause the processor to:
restore control of the account session on the first mobile device; and
process an online activity based on the first session data.

7. The system of claim 5, wherein the executable instructions further cause the processor to:
cancel the account session on the first mobile device.

8. The system of claim 1, wherein the executable instructions further cause the processor to:
receive a login request from the first mobile device, the login request comprising device information and user information;
compare the login request with device registration records; and
confirm that the first mobile device is a registered device.

9. The system of claim 1, wherein the executable instructions further cause the processor to:
provide an active control indicator or an inactive control indicator on a display of the first mobile device or on a display of the second mobile device.

10. The system of claim 1, wherein the executable instructions further cause the processor to:
provide a split screen on at least one of the first mobile device and the second mobile device,
wherein a first portion of the split screen displays the account session in an inactive control mode and a second portion of the split screen displays the account session in active control mode.

11. The system of claim 10, wherein the executable instructions further cause the processor to:
determine that the active session on the first device is in the inactive control mode; and
limit the type of actions that the first user can perform in the inactive control mode.

12. A computer program product for transferring online account sessions, the computer program product comprising:
a computer readable storage medium having computer readable program code embodied therewith, the computer readable program code comprising:
computer readable program code configured to allow a first user to launch an account session on a first mobile device via an application stored on the first mobile device; computer readable program code configured to receive first session data from the first mobile device, the first session data comprising at least one of transaction data, user input, and device tracking data;
computer readable program code configured to allow the first user to transfer control of the account session from the first mobile device to a second mobile device; and
computer readable program code configured to determine whether or not the second mobile device has control of the account session based on transmission data received from the first mobile device or second mobile device.

13. The computer program product of claim 12, further comprising computer readable program code configured to determine that the second mobile device has control of the account session; receive second session data from the second mobile device; and process an online activity based on the first action session data or the second action session data, wherein the online activity comprises at least one of inbound transactions, outbound transactions, and account updates.

14. The computer program product of claim 13, further comprising computer readable program code configured to allow the first user or a second user to return control of the account session from the second mobile device back to the first mobile device; and determine that the first mobile device is in control of the account session.

15. The computer program product of claim 12, further comprising computer readable program code configured to determine that the second mobile device does not have control of the account session; and prompt a user of the second mobile device to register the second mobile device upon determining that the second mobile device does not have control of the account session, wherein the user of the second mobile device comprises the first user or a second user.

16. The computer program product of claim 12, further comprising computer readable program code configured to receive a login request from the first mobile device, the login request comprising device information and user information; compare the login request with device registration records; and confirm that the first mobile device is a registered device.

17. A computer-implemented method for transferring online account sessions, the method comprising:
allowing a first user to launch an account session on a first mobile device via an application stored on the first mobile device;
receiving first session data from the first mobile device, the first session data comprising at least one of transaction data, user input, and device tracking data;
allowing the first user to transfer control of the account session from the first mobile device to a second mobile device; and
determining, by a processor, whether or not the second mobile device has control of the account session based on transmission data received from the first mobile device or second mobile device.

18. The computer-implemented method of claim 17, further comprising:
determining, by a processor, that the second mobile device has control of the account session;
receiving second session data from the second mobile device; and
processing, by a processor, an online activity based on the first action session data or the second action session data,
wherein the online activity comprises at least one of inbound transactions, outbound transactions, and account updates.

19. The computer-implemented method of claim 18, further comprising:
allowing the first user or a second user to return control of the account session from the second mobile device back to the first mobile device; and
determining, by a processor, that the first mobile device is in control of the account session.

20. The computer-implemented method of claim 17, further comprising:
determining, by a processor, that the second mobile device does not have control of the account session; and
prompting, by a processor, a user of the second mobile device to register the second mobile device upon determining that the second mobile device does not have control of the account session,
wherein the user of the second mobile device comprises the first user or a second user.
